(19) United States
(12) Patent Application Publication
(10) Pub. No.: US 2008/0127407 A1
(43) Pub. Date: Jun. 5, 2008

(54) HYDROTHERAPY EQUIPMENT JET WITH OVERMOLDED GASKET

(76) Inventor: Russ Wooten, Oxford, GA (US)

Correspondence Address: POWELL GOLDSTEIN LLP, ONE ATLANTIC CENTER FOURTEENTH FLOOR, 1201 WEST PEACHTREE STREET NW, ATLANTA, GA, 30309-3488, US

(21) Appl. No.: 11/549,993

(22) Filed: Oct. 17, 2006

(51) Int. Cl. A61H 33/04

(52) U.S. Cl. 4/541.6

(57) ABSTRACT

A component for hydrotherapy equipment with an overmolded gasket seal to provide a high degree of sealing and compression uniformity to the component housing as well as to the outer shell of the hydrotherapy equipment, the resulting seal reducing gapping between the overmolded gasket and the component as well as the equipment's shell, thus improving water resistance and enhancing the performance of the component and extending the life of the component.

### BACKGROUND OF THE INVENTION

1. Technical Field

The present invention is directed generally to components for use in hydrotherapy equipment, and to methods and devices for attaching such components to the wall or shell of the hydrotherapy equipment. The present invention is directed more specifically to jets having an overmolded gasket seal for use in hydrotherapy equipment, the jet having an overmolded gasket seal permanently attached to the jet for ease of attachment to the hydrotherapy equipment and for better water sealing properties.

2. Related Art

Conventional spas, hot tubs, whirlpool baths, swimming pools and the like, hereinafter referred to and defined as hydrotherapy equipment, comprise components and features, such as jet heads which inject water together with air, if desired, using venturi nozzles or jets, against the bodies of occupants usually partially immersed therein, nozzles, shower heads and waterfalls or features, hereinafter referred to collectively and defined as jets. Such jets allow the occupant to control the water input to the hydrotherapy equipment.

By way of example, typical hydrotherapy equipment with jets mounted thereon or therethrough are constructed as a molded shell to form a water containment or fluid enclosure having a footwell or floor and an upstanding sidewall. Molded within the enclosure are a plurality of therapy stations which may include seats or platforms for reclining. The shell typically is constructed of fiberglass, plastic or a similar material, or a composite of such materials. One or more pumps usually are placed under the shell (the dry-side) to draw water from the enclosure and discharge it, usually with air, into the enclosure (the wet-side) through a plurality of jets of various types, including venturi-type jets. The jets usually are mounted through the shell in either or both of the floor and sidewall. Typically, jets mounted through the sidewall are located below the water line of the hydrotherapy equipment, and therefore are in a prime location for leakage of water from the wet-side to the dry-side of the hydrotherapy equipment.

Known hydrotherapy equipment uses sealing gaskets, such as rubber and silicone washes and other common and exotic gasket materials, and sealants to prevent water leakage from the wet-side to the dry-side (including both the exterior of the hydrotherapy equipment and the area in which the operating equipment for the hydrotherapy equipment is located) through openings in the wall of the hydrotherapy equipment wherein the component or feature is mounted. Typically, leakage problems arise because of varying thickness of the shell wall cross section of the hydrotherapy equipment or irregularly shaped mounting holes through the shell wall preventing the component or feature from reliably sealing against the hydrotherapy equipment wall. Other leakage problems can arise from improperly fitting gaskets or improper installation of the gasket or jet.

Known sealing solutions involve attempting the use of a rubber or silicone washer, an O-ring or the like. Prior art solutions have, however, proven to be less than optimal because of a lack of uniform adhesion between the jet flange and the shell or shifting or misalignment of the gasket relative to the jet flange and the mounting hole. As a result, gaps are present around the gasket seal, allowing water infiltration between the jet and the gasket and/or the gasket and the equipment wall to occur. Further, when installing hydrotherapy components or features, such as spa jets and controllers, the installer first must marry a washer or other sealing device to the component, and then install the component to the hydrotherapy wall. This involves handling two or more items, the component and the gasket, in an often cramped environment, when dropping one or the other can cause a time-consuming delay. Therefore, it would be advantageous to have hydrotherapy components that do not require the use of a separate gasket.

Accordingly, there is a need for a jet combined with a sealing gasket into a single one-piece unit that is easy to install without the need for piecing together two or more components. There also is a need for a jet that better seals against the wall and/or within the mounting hole of hydrotherapy equipment so as to better prevent leakage from the wet-side to the dry-side of hydrotherapy equipment. There also is a need for such a combined jet and gasket that is easy to use and manufacture, and is economical to make. It is to this need and others that the present invention is directed.

### BRIEF SUMMARY OF THE INVENTION

The present invention provides a hydrotherapy equipment component, for example a jet, with an overmolded gasket seal allowing for easier installation and better sealing to the shell wall of the hydrotherapy equipment. The overmolded gasket seal provides a high degree of sealing and compression uniformity to the jet housing as well as to the outer shell of the hydrotherapy equipment. The resulting seal reduces gapping between the overmolded gasket and the jet as well as the hydrotherapy equipment shell, thus improving water resistance, preventing water leakage, and increasing the ease of installing or re-installing the jet. Accordingly, the performance of the jet and the hydrotherapy equipment is enhanced, the life of the jet is extended, the installation and set-up time for the hydrotherapy equipment is decreased, and the installation and set-up time for exchanging jets or installing additional jets is decreased.

More specifically, the overmolding material preferably is molded onto the jet at a location where a washer or other gasket material would reside, namely along the shoulder or hip of the jet housing that contacts the hydrotherapy equipment wall at the location where the jet extends through the hydrotherapy equipment wall. Thus, the overmolding material contacts the hydrotherapy equipment shell and extends between the jet housing and the hydrotherapy equipment shell to provide a sealing gasket.

The overmolding gasket material preferably is injection molded over the substrate component jet housing by, for example, dual-shot or multi-shot processes, resulting in the present invention. The overmolding gasket material can comprise an elastomeric resin, other polymers and rubbers, or silicones. The material selected for the overmolding sealing gasket preferably is resilient, waterproof and has an ability to adhere to the substrate component jet housing, which itself generally comprised of a plastic material.

One feature the invention is a waterproof overmolded component seal for hydrotherapy equipment with an improved water resistant seal. Another feature of the invention is a hydrotherapy equipment jet gasket with improved uniformity of compression and adhesion between a waterproof overmolded gasket seal on the back surface of the jet's flange. Another feature of the invention is a hydrotherapy equipment component with improved uniformity of compression between a waterproof overmolded gasket seal on the back surface of the component's flange and the hydrotherapy equipment's shell. Another feature of the invention is a hydrotherapy equipment jet having an integral sealing gasket allowing for easier and more uniform installation of the jet.

These features, and other features and advantages of the present invention will become more apparent to those of ordinary skill in the relevant art when the following detailed description of the preferred embodiments is read in conjunction with the appended drawings in which like reference numerals represent like components throughout the several views. The figures and the detailed description which follow more particularly exemplify these and other embodiments of the invention.

### BRIEF DESCRIPTION OF THE DRAWINGS

The invention may be more completely understood in consideration of the following detailed description of various embodiments of the invention in connection with the accompanying drawings, which are as follows.

FIG. 1 illustrates an exemplary hydrotherapy component with a conventional gasket.

FIG. 2 is one embodiment of a gasket seal overmolded on an exemplary hydrotherapy component.

### DETAILED DESCRIPTION OF THE PREFERRED EMBODIMENTS

While the invention is amenable to various modifications and alternative forms, specifics thereof are shown by way of example in the drawings and described in detail herein. It should be understood, however, that the intention is not to limit the invention to the particular embodiments described. On the contrary, the intention is to cover all modifications, equivalents, and alternatives falling within the spirit and scope of the invention. Thus, it will be understood that the hydrotherapy equipment jets described and illustrated herein are exemplary and, as defined herein, comprise jets, nozzles, shower heads, waterfalls, waterspouts, water features, drains, suction fittings, air controls, diverter valves, filter canisters, light housings, and the like, having overmolded gaskets, each of which is within the scope of the present invention, and all of which are referred to as jets throughout the specification for simplicity. Further, it will be understood that the hydrotherapy equipment described and illustrated herein is exemplary and, as defined herein, comprise spas, tubs, pools, showers, baths, ponds, Jacuzzis, and the like, each of which is within the scope of the present invention, and all of which are referred to as spas throughout the specification for simplicity.

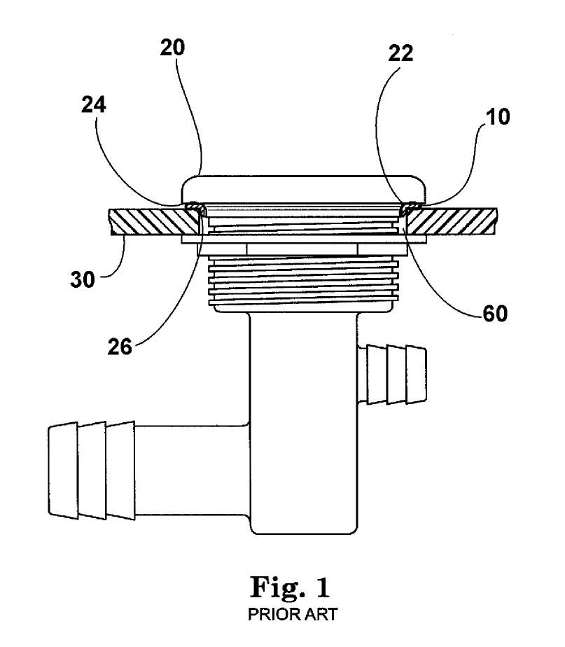

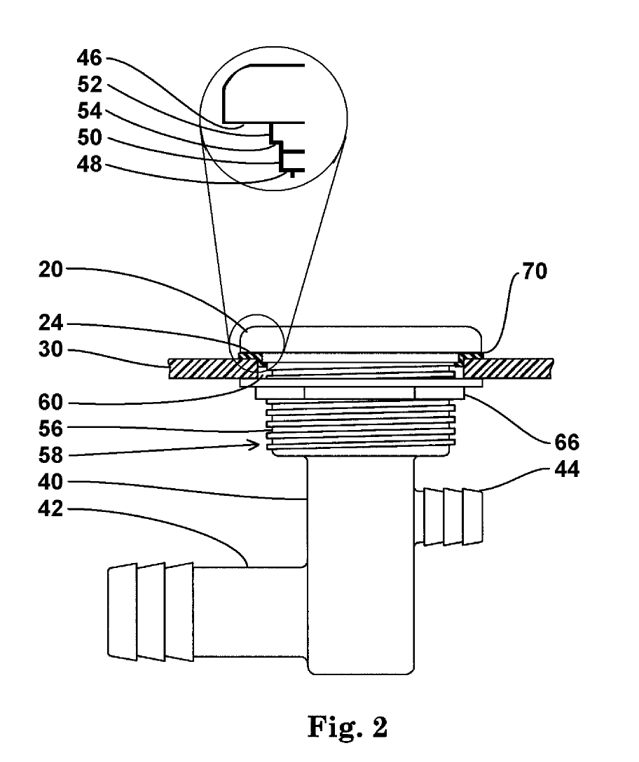

FIG. 1 illustrates an exemplary prior art hydrotherapy component with a conventional gasket, the conventional gasket being separate from (not a part of) the hydrotherapy component. FIG. 2 is one embodiment of a gasket seal overmolded onto an exemplary hydrotherapy component, namely a jet.

Conventional known hydrotherapy jets typically are manufactured without a sealing mechanism integrated thereon. As a result, conventional jets are sealed upon installation onto a hydrotherapy spa shell through the use of common gaskets, typically washers, O-rings or the like. As illustrated in FIG. 1, a conventional gasket 10 is interposed between an exemplary jet 20 and an exemplary spa shell or wall 30. This approach presents a number of problems. First, a lack of uniformity of adhesion and/or uniformity of compression of the gasket 10 between the jet 20 and the shell 30 manifests as bubbles or gaps 22 therebetween. These bubbles or gaps 22 are the result of, among other things, a failure of the gasket 10 to accommodate irregularities present on the surface of jet 20, an uneven or improperly shaped mounting hole 60, or an improperly sized mounting hole 60. Moreover, exemplary jet 20 is illustrated with a flange 24. The conventional gasket 10 illustrated fails to fill and seal the region between the shell 30 and the jet's flange 24, leaving a gap 26 therebetween. A conventional gasket such as that shown in FIG. 1 is provided in U.S. Pat. No. 6,691,336 (Buck), the contents of which are hereby incorporated in their entirety. The result of the failings described above is water infiltration and, ultimately, failure of the gasket 10.

Turning to FIG. 2, a preferred embodiment of the present invention is provided. A exemplary jet 20, similar to that shown in FIG. 1, is illustrated comprising, among other things, a housing 40 with a water inlet port 42 and an air inlet port 44 integrally formed therethrough. The water inlet port 42 admits water into the jet 20 and the air inlet port 44 admits air into the jet 20. This particular embodiment thus illustrates a venturi-type jet, wherein water and air are mixed to provide a therapeutic effect. Those skilled in the art will readily recognize other equivalent non-venturi-type hydrotherapy jets, each of which are within the scope of the present invention.

The jet housing 40 further defines an enlarged outer flange 24 with an upper surface 46, a lower surface 48, a stepped lip 50 adjacent the lower surface 48 and screw threads 56 formed on a cylindrical portion 58 adjacent the stepped lip 50. The stepped lip 50 comprises a perpendicular section 52 essentially perpendicular to the lower flange surface 48 and a parallel section 54 essentially parallel to the lower flange surface 48 and essentially perpendicular to the perpendicular section 52. The screw threads 56 are formed on the cylindrical portion 58, which is essentially perpendicular to the flange lower surface 48. A nut 66 is illustrated as having mating communication with the screw threads 56 so that tightening the nut 66 tightens the jet 20 against the spa shell 30.

The upper surface 46 of the flange 24 has a relatively sharp transition between the upper surface 46 and the perpendicular section 52. The jet 20 illustrated is exemplary, as a result, a variety of housing constructions are possible, including provision of a plurality of transitional interfaces as described above as well as variation in the sharpness or smoothness of the transitional interfaces. Those skilled in the art will recognize various equivalent jet housing constructions, each of which is within the scope of the present invention.

Continuing with FIG. 2, an overmolded gasket seal 70 is illustrated overmolding and covering the flange upper surface 46 and the perpendicular section 52. In this embodiment, the surfaces of the flange upper surface 46 and the perpendicular section 52 serve as the substrate to which the overmolded gasket seal 70 is adhered. Thus, the overmolded gasket seal 70 covers the substrate surface extending from the upper surface 46 to the sharp transition to the perpendicular section 52. In alternate embodiments, the overmolded gasket seal 70 may cover the parallel surface 54, and the parallel surface 54 and the stepped lip 50, or any variation thereof. The skilled artisan will recognize the various possibilities for the jet housing 40 construction and the sealing of the jet 20 interface with the hydrotherapy equipment. The present invention is sufficiently broad to accommodate all possible jet housing 40 constructions, interfaces and the sealing thereof using an overmolded gasket seal 70. Therefore, it is desirable, as will be discussed further below, but not necessary, that the overmolded gasket seal 70 terminate at a relatively sharp transitional interface.

Because the overmolded gasket seal 70 is overmolded onto the surfaces of the substrate jet housing 40, there is a high degree of adhesion uniformity, conforming with and accommodating for any substrate surface irregularities on the housing 40. Thus, gapping is minimized between the overmolded gasket seal 70 and the jet housing 40, and uniformity of adhesion is maximized between the overmolded gasket seal 70 and the jet housing 40.

Installation of the jet 20 with the overmolded gasket seal 70 molded thereto onto the shell 30 involves inserting the jut 20 through a mounting hole 60 in shell 30 from the front-side or wet-side and then screwing exemplary nut 60 into the screw threads 56 from the back-side or dry-side. This will bring the overmolded gasket seal 70 into compressing contact with the shell 30, creating a seal that is uniform and substantially free of gaps. Further, as the overmolded gasket seal 70 is adhered to the jet housing 40, the overmolded gasket seal 70 cannot slide or slip relative to the jet housing 40, and therefore will reduce or eliminate the tendency for gaps related to such slippage or slidage, which can occur in the prior art multi-piece configurations.

One illustrative embodiment of the overmold gasket seal 70 is illustrated in FIG. 2 as extending radially outwardly from the perpendicular section 52 along the upper surface 46 and then outwardly beyond the flange 24. Another embodiment of the present invention comprises a smooth transition between the overmold gasket seal 70 and the outer edge of the upper surface 46. In this alternate embodiment, the overmold gasket seal 70 extends radially only to the edge of the upper surface 46, but not beyond. Because the overmolding process presents a high conforming adhesive seal with the jet housing 40, various embodiments of the invention may comprise the overmold gasket seal 70 covering at least part of the upper surface 46, wherein the outermost radial portion of the upper surface 46 may not be covered by the overmold gasket seal 70. Further, the overmold gasket seal 70 of the present invention comprises, in various embodiments, a substantially uniformly thick layer when overmolded onto the jet housing 40.

Generally, the overmolding gasket seal 70 preferably is molded onto the jet 20 at a location where a washer or other gasket material would reside, namely along the shoulder or hip of the jet housing 40 that contacts the shell 30 at the location where the jet 20 extends through the shell 30. Thus, the overmolding gasket seal 70 contacts the shell 30 and extends between the jet housing 40 and the shell 30 to provide a sealing gasket.

More specifically, the overmolded gasket seal 70 is injection molded over portions of the substrate jet housing 40 by methods that are well known to those skilled in the art, including but not limited to, multi-shot processes or insert molding techniques. The overmolded gasket seal 70 may comprise an elastomeric resin. For example, the overmolding may comprise, without limitation, thermoplastic elastomer (TPE) and thermoplastic vulcanizates (TPV) as well as other thermoplastics and silicones, including combinations of thermoplastics and of thermoplastics and silicones. The material selected for the overmolding preferably is resilient, waterproof and has an ability to adhere to the substrate jet housing 40, which is generally comprised of a plastic material, including but not limited to acrylonitrile butadiene styrene (ABS), acrylonitrile ethylene styrene (AES), polycarbonate (PC), thermoset plastics, ceramics, metals, glass, and the like. Those skilled in the art will recognize a range of equivalent materials, each of which is within the scope of the present invention.

Thus, the present invention provides a hydrotherapy equipment component, for example a jet 20, with an overmolded gasket seal 70 allowing for easier installation and better sealing to the shell 30 wall of the hydrotherapy equipment. The overmolded gasket seal 70 provides a high degree of sealing and compression uniformity to the jet housing 40 as well as to the outer shell 30 of the hydrotherapy equipment. The resulting seal reduces gapping between the overmolded gasket seal 70 and the jet 20 as well as the shell 30, thus improving water resistance, preventing water leakage, and increasing the ease of installing or re-installing the jet 20. Accordingly, the performance of the jet 20 and the hydrotherapy equipment is enhanced, the life of the jet 20 is extended, the installation and set-up time for the hydrotherapy equipment is decreased, and the installation and set-up time for exchanging jets 20 or installing additional jets 20 is decreased.

The foregoing detailed description of the preferred embodiments and the appended figures have been presented only for illustrative and descriptive purposes and are not intended to be exhaustive or to limit the scope and spirit of the invention. The embodiments were selected and described to best explain the principles of the invention and its practical applications. One of ordinary skill in the art will recognize that many variations can be made to the invention disclosed in this specification without departing from the scope and spirit of the invention.

What is claimed is:

1. A component for hydrotherapy equipment comprising:
a) a housing comprising a flange with a lower surface and an upper surface; and
b) an overmolded gasket seal overmolded to cover at least a portion of the housing.

2. The component of claim 1, wherein the overmolded gasket seal is overmolded to cover at least a portion of the lower surface of the flange.

3. The component of claim 1, wherein the overmolded gasket seal covers all of the lower surface of the flange and extends radially outwardly beyond the lower surface of the flange.

4. The component of claim 1, wherein the housing further comprises:
c) a stepped lip adjacent the lower surface, the stepped lip comprising a step section and a lip section; and
d) a cylindrical portion comprising screw threads, wherein the overmolded gasket seal is further overmolded to cover at least a portion of the step section of the stepped lip.

5. The component of claim 4, wherein the overmolded gasket seal is further overmolded to cover all of the step section of the stepped lip.

6. The component of claim 4, wherein the overmolded gasket seal is further overmolded to cover at least a portion of the lip section of the stepped lip.

7. The component of claim 6, wherein the overmolded gasket seal is further overmolded to cover all of the lip section of the stepped lip.

8. The component of claim 1, further comprising a molded sealed interface between the overmolded portion of the housing, wherein the molded sealed interface is substantially uniformly adhered to the housing.

9. The component of claim 1, further comprising a molded sealed interface between the overmolded portion of the housing wherein the overmolded portion of the housing comprises surface irregularities and wherein the molded sealed interface substantially conforms to the surface irregularities of the housing.

10. The component of claim 1, further comprising the overmold gasket seal having a thickness that is substantially uniform.

11. The component of claim 1, further comprising a smooth transition between the overmold gasket seal and the upper surface of the flange.

12. The component of claim 1, wherein the overmold gasket seal comprises thermoplastic elastomer.

13. The component of claim 1, wherein the overmold gasket seal comprises thermoplastic vulcanizates.

14. The component of claim 1, wherein the jet housing comprises a material selected from the group consisting of acrylonitrile butadiene styrene, acrylonitrile ethylene styrene, polycarbonate, metals, ceramics, and glasses.

15. A component for hydrotherapy equipment comprising:
a) a housing having a surface;
b) an overmolded gasket seal overmolded to cover at least a portion of the housing surface, wherein the overmolded gasket seal forms a molded sealed interface therebetween and substantially conforms to the housing surface; and
c) at least one overmold shutoff.

16. A method for uniformly sealing the interface between a hydrotherapy equipment jet and the equipment in which the jet is installed, comprising the steps of:
a) providing a jet having a housing that interfaces with the hydrotherapy equipment;
b) overmolding a portion of the jet housing with a waterproof material to create a substantially uniformly overmolded seal between the jet housing and the overmold;
c) installing the overmolded jet housing in the hydrotherapy equipment; and
d) creating a waterproof, uniform and conforming seal between the overmold and the hydrotherapy equipment by compressing the overmold between the jet housing and the hydrotherapy equipment.
